(19) United States
(12) Patent Application Publication
(10) Pub. No.: US 2006/0264523 A1
(43) Pub. Date: Nov. 23, 2006

(54) Polyvinyl chloride foams

(76) Inventors: Min-hee Lee, Daejeon (KR); Bong-keun Lee, Daejeon (KR); Ki-deog Choi, Daejeon (KR)

Correspondence Address: MCKENNA LONG & ALDRIDGE LLP, 1900 K STREET, NW, WASHINGTON, DC, 20006, US

(21) Appl. No.: 10/546,299

(22) PCT Filed: Feb. 18, 2004
(86) PCT No.: PCT/KR04/00328

§ 371 Date: Jul. 7, 2006

(30) Foreign Application Priority Data
Feb. 19, 2003 (KR) 10-2003-0010443

(51) Int. Cl. C08J 9/00

(52) U.S. Cl. 521/99

(57) ABSTRACT

The present invention relates to the foams of the polyvinyl chloride nanocomposites comprising of polyvinyl chloride, layered inorganic compounds, and foaming agents. They are effective in that they have superior mechanical strength and non-flammability even with a low specific gravity; demostrates a high foaming efficiency even with a small amount of a foaming agent; and have an even microcellular structure.

### TECHNICAL FIELD

The present invention relates to polyvinyl chloride foams. In particular, the present invention relates to the foams of the polyvinyl chloride nanocomposites comprising of polyvinyl chloride, layered silicates, and foaming agents. Because of the layered silicates dispersed onto the vinyl chloride resins, the foaming efficiency of the foaming agent is extensively improved so that the foam of the polyvinyl chloride nanocomposites show a superior mechanical strength and an improved non-flammability. Even with a small amount of the foaming agent, a high foaming efficiency will be easily achieved, so that the microcellular structure having relatively smaller cell size compared to the conventional foam can be manufactured.

### BACKGROUND ART

Materials having unique physical properties have been required in order to accommodate the unique industrial characteristics in highly technical industries such as electronic, aeronautic, and automobile industries. One of the materials is a high-performance polymer composites, particularly, nanocomposites. Among such nanocomposites, polymer-clay nanocomposites are composites that the clay particles are well dispersed into polymer media as the form of platelets after the exfoliation or intercalation of the clay. Due to the large surface area and a high aspect ratio of exfoliated layers, the properties including physical and mechanical properties, dimensional stability, thermal stability, barrier properties, heat resistance temperature, non-flammability and the light-weight characteristic, can be improved by simply adding a small amount of clay into polymer resins.

Prior technologies related to such polymer-clay nanocomposites include the preparing methods of polyimide nanocomposites using organically pretreated clays, and also include many methods for preparing nanocomposites based on various thermoplastic and thermosetting resins.

In the manufacture of nanocomposites for improving their properties, it has been known that the pretreatment process of clays with organic materials is very important for the exfoliation or intercalation in polymer resins. There are two ways of the organic pretreatment of clays, a chemical treatment method and a physical treatment method.

The chemical treatment methods are disclosed in the U.S. Pat. No. 4,472,538, No. 4,546,126, No. 4,676,929, No. 4,739,007, No. 4,777,206, No. 4,810,734, No. 4,889,885, No. 4,894,411, No. 5,091,462, No. 5,102,948, No. 5,153,062, No. 5,164,440, No. 5,164,460, No. 5,248,720, No. 5,382,650, No. 5,385,776, No. 5,414,042, No. 5,552,469, No. 6,395,386, International Publications No. WO93/04117, No. WO93/04118, No. WO93/11190, No. WO94/11430, No. WO95/06090, No. WO95/14733, D. J. Greeland, J. Colloid Sci. 18, 647 (1963), Y. Sugahara et al., J. Ceramic Society of Japan 100, 413 (1992), P. B. Massersmith et al., J. Polymer Sci.: Polymer Chem., 33, 1047 (1995), C. O. Sriakhi et al., J. Mater Chem., 6, 103 (1996), etc.

Also, physical treatment methods are disclosed in the U.S. Pat. No. 6,469,073 and No. 5,578,672. The former one is a method of exfoliation of a layered structure by rapidly expanding the layered silicate particles followed by the sufficient contact with supercritical fluids. The latter is a method of processing of the clays directly with polymer resin and organics with same time without the pretreatment step.

It has been known that the resins applicable to such polymer-clay nanocomposites include polyolefin such as polypropylene and polyethylene, and polyamides, polyesters, polystyrene, polycarbonate, and polyvinyl alcohols, etc. The Korean Patent Laid-Open No. 19950023686 and the U.S. Pat. No. 6,271,297 disclose nanocomposites using polyvinyl resins. Particularly, disclosed in the U.S. Pat. No. 6,271,297 are about the composites having an exfoliated structure due to the chemical affinity with clays without a swelling agent such as an epoxy, etc. If no epoxy is added, the decomposition of vinyl chloride resins occurs rapidly due to the cations existing on the surface of the clays; while the decomposition of resins is reduced significantly if an epoxy is added.

In the meantime, foams for soundproofing agents, adiabatic agents, building materials, light-structured materials, packing materials, insulation materials, cushion materials, dustproofing agents, shoes, etc. with which plastics are foamed mechanically or by using foaming gases or foaming agents for the purposes of insulation, sound absorption, buoyancy, elasticity, light weight, soundproofing, etc. may be manufactured by using physical or chemical foaming agents.

Physical foaming agents include carbon dioxide, nitrogen, hydrofluorocarbon, etc., and chemical foaming agents include organic compounds generating various gases when they are decomposed such as azodicarbonamide, etc. According to the U.S. Pat. No. 6,225,365 related to the above, it may be possible to obtain more superior foams by using physical foaming agents rather than chemical foaming agents since there are almost no residual materials, while the physical properties of final products are reduced during foaming of vinyl chloride resins since there remain residual materials after chemical foaming agents are decomposed.

Also, foams may be divided into reinforced polymer resin foams and non-reinforced polymer resin foams according to the addition of glass fibers, wood particles, etc., or into foams having a microcellular structure in which the size of cells is very small and foams having a general cell structure in which the size of cells is relatively large according to the size of cells after they are foamed.

Many types of technologies have been developed for such foams, and there have been attempts to develop foams by using composite materials recently. Disclosed in the U.S. Pat. No. 6,054,207 are foams for light but sturdy construction materials using the composites of thermoplastic resins and woods. Further disclosed in the U.S. Pat. No. 6,344,268 are low-specific-gravity foams for construction materials using the composites of thermoplastic resins and wood fibers and chemical foaming agents. However, they fall short of consumers' expectation in their physical properties and foaming performance since they use chemical foaming agents and have a general-size foaming cell structure, not a microcellular structure.

### DISCLOSURE OF INVENTION

In order to solve the above-described problems, the purposes of the present invention are to provide with polyvinyl chloride foams with the improved mechanical strength and non-flammability, and to demonstrate a high foaming efficiency even with a small amount of a foaming agent, and to generate microcellular foams having the closed cell structure so that the polyvinyl chloride foams shows the improved properties as mentioned earlier. In other words, in order to achieve the above-described objects, polyvinyl chloride foams disclosed in the present invention comprises vinyl chloride resin-layered silicate nanocomposites, in which the layered silicates are dispersed onto the vinyl chloride resins containing foaming agents.

The above-described polyvinyl chloride foams may be comprised of one or more kinds of additives selected from the compound consisting of tin type, calcium-zinc type, and lead type thermal stabilizers; acrylic type, butadiene type and CPE type impact modifiers; and calcium carbonate and acrylic processing aids.

The above-described polyvinyl chloride foams may have the specific gravity of said polyvinyl chloride foams is 0.3 to 1.5, or the cell density is 10⁸ to 10¹² cells/cm³, or the average cell size is 1 to 100 μm.

The above-described polyvinyl chloride foams may be comprised of 0.01 to 10 parts by weight of said layered silicate and 0.01 to 10 parts by weight of said foaming agent based on 100 parts by weight of said vinyl chloride resin.

The above-described layered silicate may be a smectite-group mineral selected from the group consisting of montmorillonite, bentonite, hectorite, fluorohectorite, saponite, beidelite, nontronite, stevensite, vermiculite, volkonskoite, sauconite, magadite, kenyalite, and their derivatives.

The above-described foaming agent may be selected from the group consisting of chemical foaming agents, physical foaming agents, and the mixture of chemical foaming agents and physical foaming agents.

The above-described chemical foaming agents may be selected from the group consisting of azodicarbonamide, azodiisobutyro-nitrile, benzenesulfonhydrazide, 4,4-bxybenzene sulfonyl-sericarbazide, p-toluene sulfonyl-semi-carbazide, barium azodicarboxylate, N,N′-dimethyl-N,N′-dinitrosoterephthalamide, and trihydrazino triazine.

The above-described physical foaming agents may be inorganic foaming agents selected from the group consisting of carbon dioxide, nitrogen, argon, water, air, and helium; or organic foaming agents selected from the group consisting of aliphatic hydrocarbons containing 1 to 9 carbon atoms, aliphatic alcohols containing 1 to 3 carbon atoms, and halogenated aliphatic hydrocarbons containing 1 to 4 carbon atoms.

The present invention is illustrated in more detail as follows:

The present invention provides with polyvinyl chloride foams comprising vinyl chloride resin-clay nanocomposites and foaming agents, so that the present invention have improved physical properties such as mechanical properties, anti-combustibility, foaming ability, etc.

The above-described vinyl chloride resin-clay nanocomposites have a form in which a layered silicate is dispersed onto vinyl chloride resins. That layered silicate is a compositional constituent assuming an important role in improving physical properties of polyvinyl chloride foams of the present invention. In other words, since the layered silicate is dispersed onto vinyl chloride resins, the mechanical strength is increased and anti-combustibility is improved as the radiant heat is cut off. Also, the layered silicate enables the formation of microcellular structured foams having superior mechanical properties even with a low specific gravity by preventing escaping of a foaming agent during the formation of microcells and thus demonstrating a high foaming efficiency even with a small amount of the foaming agent; facilitating the formation of the microcellular structure through the nucleating effect on the surface of the layered silicate; and interfering the coalescence of cells by affecting the movement of the viscosity of resins during foaming and thus assisting the formation of closed cells.

Microcells refer to the cells of which density is 10⁹ to 10¹⁵ cells/cm³ or of which size is 20 to 100 μm. It is preferable that the microcells formed in the polyvinyl chloride foams of the present invention have a specific gravity of 0.3 to 1.5, density of 10⁸ to 10¹² cells/cm³ and size of 1 to 100 μm. If the specific gravity of the foams is less than 0.3, the effect of improvement of physical properties shown when the layered silicate is foamed is not shown; and if it exceeds 1.5, it is difficult to manufacture foams.

In order to grant specific physical properties, the present invention may further include additives such as thermal stabilizers, processing agents, impact modifiers, calcium carbonate, etc.

It is preferable that the content of the above-described additive is less than 100 parts by weight based on 100 parts by weight of the vinyl chloride resin. If the content of the additive is 100 parts by weight or more, the effect of improvement of physical properties of foams shown by including the layered silicates becomes insignificant and it becomes difficult to maintain the characteristics of vinyl chloride resins.

The vinyl chloride resins of the present invention may be vinyl chloride homopolymers; copolymers of vinyl chloride and vinyl chloroacetate; or mixed polymers of ethylene vinyl acetate, ionized polyethylene resins, chlorosulfopolyethylene, acrylobutadiene rubber, acryl butadiene styrene rubber, isoprene rubber, natural rubber, etc.

The layered silicate of the present invention contributes to the improvement of physical properties of foams as it is dispersed onto the vinyl chloride resin. The layered silicate may be a natural or synthetic layered silicate. Preferably, it is a smectite-group mineral such as montmorillonite, bentonite, hectorite, fluorohectorite, saponite, beidelite, nontronite, stevensite, vermiculite, volkonskoite, sauconite, magadite, kenyalite; and their derivatives. Such derivatives include smectite-group layered silicates processed organically with a quarternary ammonium salt having octadecyl, hexadecyl, tetradecyl, dodecyl radicals, etc.

It is preferable that the content of the above-described layered silicate is 0.01 to 10 parts by weight based on 100 parts by weight of the vinyl chloride resin. If its content is less than 0.01 parts by weight, it is not possible to expect the effects of the layered silicate; and if it exceeds 10 parts by weight, the physical properties, i.e., the elongation ratio and impact strength, may be lowered rather due to an excessive amount of the mineral.

Also, the foaming agent of the present invention may be selected from the group consisting of chemical foaming agents, physical foaming agents, and the mixture of chemical and physical foaming agents. It is preferable that any of compounds decomposed at a temperature higher than a specific temperature and generating gases is acceptable for the above-described chemical foaming agents, which may be selected from the group consisting of azodicarbonamide, azodiisobutyro-nitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, etc.

Further, the physical foaming agents may be inorganic foaming agents such as carbon dioxide, nitrogen, argon, water, air, helium, etc.; or organic foaming agents such as aliphatic hydrocarbons containing 1 to 9 carbon atoms; aliphatic alcohols containing 1 to 3 carbon atoms; halogenated aliphatic hydrocarbons containing 1 to 4 carbon atoms, etc. The above-described aliphatic hydrocarbons may be methane, ethane, propane, n-butane, isobutane, n-pentane, isopentane, neopentane, etc. The aliphatic alcohols may be methanol, ethanol, n-propanol, isopropanol, etc. The halogenated aliphatic hydrocarbons may be methyl fluoride, perfluoromethane, ethyl fluoride, 1,1-difluoroethane (HFC-152a), 1,1,1-trifluoroethane (HFC-143a), 1,1,1,2-tetrafluroethane (HFC-134a), 1,1,2,2-tetrafluoroethane (HFC-134a), 1,1,2,2-tetrafluoroethane (HFC-134), 1,1,1,3,3-pentafluorobutane (HFC-365 mfc), 1,1,1,3,3-pentafluoropropane (HFC.sub-13245fa), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane, methyl chloride, methylene chloride, ethyl chloride, 1,1,1-trichloroethane, 1,1-dichloro-1-fluoroethane (HCFC-141b), 1-chloro-1,1-didifluoroethane (HCFC-142b), chlorodifluoromethane (HCFC-22), 1,1-dichloro-2,2,2-trifluoroethane (HCFC-123), 1-chloro-1,2,2,2-tetrafuoroethane (HCFC-124), trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, dichlorohexafluoropropane, etc.

It is preferable that the content of the foaming agent as described in the above is 0.01 to 10 parts by weight based on 100 parts by weight of the mixture of vinyl chloride resins, additives, and layered silicate. If the content of the foaming agent is less than 0.01 part by weight, the effect of foaming is insignificant or it is not possible to expect it at all as the amount of generation of gases for foaming is too small; and if it exceeds 10 parts by weight, it is difficult to expect the improvement of physical properties since the amount of generation of gases is too large.

One preferred embodiment of the method of manufacture of polyvinyl chloride foams as described in the above is illustrated below:

5 to 10 parts by weight of a tin-group composite thermal stabilizer, 5 to 10 parts by weight of an acrylic impact modifier, 1 to 10 parts by weight of calcium carbonate, 0.1 to 5 parts by weight of an acrylic processing agent, and 0.01 to 10 parts by weight of a montmorillonite-group layered silicate based on 100 parts by weight of a vinyl chloride resin is mixed well and inputted into a compressor. After the resins inputted into the compressor are plasticized completely and the air flowed in and other residual gases are removed with a vacuum pump, 0.01 to 10 parts by weight of carbon dioxide (an inorganic foaming agent) based on 100 parts by weight of the vinyl chloride resin is inputted by using a high-pressure pump. The temperature of the compressor is maintained at 150 to 210° C. and the screw rotation speed is adjusted to 70 rpm in order to prevent carbon dioxide inputted from being leaked out to the vacuum portion of the upper flowing portion. Foams are formed by the steps of changing the air flowed in and carbon dioxide inputted into the supercritical state due to the high temperature and pressure generated from the compressor; and mixing sufficiently carbon dioxide as a foaming agent and the nanocomposite resin composition composed of the vinyl chloride resin and a layered silicate. When manufacturing foams having a microcellular structure by adding a foaming agent after manufacturing the nanocomposite resin composition composed of the vinyl chloride resin and a layered silicate as described in the above or when manufacturing foams having a microcellular structure by simultaneously mixing the vinyl chloride resin, a layered silicate, and a foaming agent; the pressure in the compressor should be maintained to be high through the optimum screw combination in order to melt completely the foaming agent added.

### BEST MODE FOR CARRYING OUT THE INVENTION

A more complete appreciation of this invention, and many of the attendant advantages thereof, will be readily apparent as the same becomes better understood by reference to the following detailed description of preferred embodiments:

### EXAMPLE 1

5 parts by weight of a tin-group composite thermal stabilizer, 6 parts by weight of an acrylic impact modifier, 3 parts by weight of calcium carbonate, 2 parts by weight of an acrylic processing agent, and 3 parts by weight of Chloisite 30B which is a montmorillonite-group layered silicate (a product of Southern Clay Products Inc.) based on 100 parts by weight of the vinyl chloride resin was mixed well in a high-speed mixer for 10 minutes and inputted into a compressor. After the resin was plasticized completely and the air flowed into the compressor and other residual gases were removed with a vacuum pump, 3 parts by weight of carbon dioxide (a physical foaming agent) was inputted by using a high-pressure pump. The temperature of the compressor was maintained at 190° C. and the screw rotation speed was adjusted to 70 rpm in order to prevent carbon dioxide inputted from being leaked out to the vacuum portion of the upper flowing portion. Foams were manufactured after carbon dioxide inputted was changed into the supercritical state due to the high temperature and pressure generated from the compressor and was mixed with the resin composition for a sufficient time.

### EXAMPLE 2

Foams were manufactured in the same method as that in Example 1 except that the content of the montmorillonite-group layered silicate was 1 part by weight.

### EXAMPLE 3

Foams were manufactured in the same method as that in Example 1 except that 1 part by weight of azodicarbonamide was used for a chemical foaming agent instead of a physical foaming agent and the temperature of the compressor s 210° C. which is higher than the decomposition temperature of the chemical foaming agent.

### COMPARATIVE EXAMPLE 1

Foams were manufactured in the same method as that in Example 1 except that no foaming agent and the montmorillonite-group layered silicate were used.

### COMPARATIVE EXAMPLE 2

Foams were manufactured in the same method as that in Example 1 except that no foaming agent was used.

### COMPARATIVE EXAMPLE 3

Foams were manufactured in the same method as that in Example 1 except that no layered silicate was used.

### TEST EXAMPLE

The foams manufactured in Examples and Comparative Examples were manufactured to be sheets having a thickness of 2 mm and a width of 50 mm with a cutter after they were solidified sufficiently by being passed through a calibrator and a cooling water bath. The physical properties of the sheets thus manufactured were measured as described below and the results were shown in Table 2 as follows:

The specific gravity was measured according to the ASTM D792.

As to the cell density, the number of cells per cm³ was measured by observing cells with a scanning electronic microscope after wavy cross-sections were made onto the sheets.

The tensile strength and elongation ratio were measured according to the ASTM D638.

The bending strength and bending elasticity ratio were measured according to the ASTM D790.

The Izod impact strength was measured according to the ASTM D256.

Hardness was measured according to the ASTM D785.

Anti-combustibility was measured according to the UL94 test which is a method prescribed by Underwriter's Laboratory, Inc. of the United States. This is a method of evaluation of anti-combustibility from the flame-remaining time or dripping after the blaze of a burner comes in contact with a sample having a size maintained vertically for 10 seconds. The flame-remaining time is the length of time for which the sample is burnt with a flame after the source of ignition is moved far away; the ignition of a side by dripping is determined according to the ignition of a side for the cover, which is about 300 mm below the lower end of the sample, by the dripping material from the sample; and grading of anti-combustibility is classified as shown in Table 1 below:

TABLE 1

| Classification | V2 | V1 | V1 | HB |
|---|---|---|---|---|
| Flame-remaining | 30 | 30 | 10 | Impossible anti- |
| time of each | seconds | seconds | seconds | combustibility |
| sample | or less | or less | or less | |
| Total flame- | 250 | 250 | 50 | |
| remaining time of | seconds | seconds | seconds | |
| 5 samples | or less | or less | or less | |
| Ignition of a | Yes | No | No | |
| side by dripping | | | | |

TABLE 2

| | Examples | | | Comparative Examples | | |
|---|---|---|---|---|---|---|
| Classification | 1 | 2 | 3 | 1 | 2 | 3 |
| Specific | 1.07 | 1.10 | 1.13 | 1.40 | 1.40 | 1.08 |
| gravity | | | | | | |
| Density of | 3 × 10⁹ | 7 × 10⁸ | 6 × 10⁸ | * | * | 8 × 10⁶ |
| cells | | | | | | |
| (cells/cm³) | | | | | | |
| Tensile | 460 | 450 | 450 | 450 | 490 | 390 |
| strength | | | | | | |
| (kgf/cm²) | | | | | | |
| Elongation | 140 | 120 | 120 | 140 | 70 | 40 |
| ratio (%) | | | | | | |
| Bending | 730 | 730 | 720 | 720 | 810 | 580 |
| strength | | | | | | |
| (kgf/cm²) | | | | | | |
| Bending | 27,000 | 25,000 | 26,000 | 26,000 | 32,000 | 21,000 |
| elasticity | | | | | | |
| ratio (kgf/cm²) | | | | | | |
| Impact strength | No | No | No | No | 19 | 35 |
| (kgf cm/cm) | destruction | destruction | destruction | destruction | | |
| Hardness | 87 | 87 | 87 | 88 | 92 | 82 |
| (R-scale) | | | | | | |
| Anti- | V0** | V0** | V0 | V0 | V0** | V0 |
| combustibility | | | | | | |

* No microcells are formed.
**Char is formed on the surface and more superior anti-combustibility is shown compared to other examples specially.

As shown in the above Table 2, the polyvinyl chloride foams in Examples 1 to 3 manufactured by using vinyl chloride resin-clay nanocomposites in which a layered silicate was dispersed onto the vinyl chloride resin and a foaming agent according to the present invention showed similar or improved tensile strength, elongation ratio, bending strength, bending elasticity ratio, impact strength and hardness, and had a structure in which microcells were formed, compared to those in Comparative Example 1 in which no foaming agent and layered silicate were used.

Further, the foams in Comparative Example 2 manufactured by using only a layered silicate without using a foaming agent showed somewhat high tensile strength, bending strength, bending elasticity ratio, and impact strength compared to those of the foams in Examples. However, it can be known that these values were those shown when the specific gravity was higher than that in Examples, no microcells were formed, and the impact strength was very low.

Still further, the foams in Comparative Example 3 manufactured by using only a foaming agent without using a layered silicate showed low tensile strength, elongation ratio, bending strength, bending elasticity ratio, impact strength, hardness, and degree of anti-combustibility compared to those of the foams in Examples. It can be known that in case of using only a foaming agent, the cells was formed, but the cells were not even compared to those in Examples due to the low density thereof.

### INDUSTRIAL APPLICABILITY

The present invention is a useful invention in that polyvinyl chloride foams according to the present invention comprise vinyl chloride resin-clay nanocomposites and foaming agents, and thus show a superior mechanical strength and an increased non-flammability even with a low specific gravity, show a high foaming efficiency even with a small amount of the foaming agent, and have an even microcellular structure.

While certain present preferred embodiments of the invention have been shown and described, it is to be distinctly understood that the invention is not limited thereto but may be otherwise variously embodied and practiced within the scope of the following claims.

What is claimed is:

1. Polyvinyl chloride foams comprising vinyl chloride resin-layered silicate nanocomposites, in which layered silicates are dispersed onto the vinyl chloride resin containing foaming agents.

2. The polyvinyl chloride foams according to claim 1, comprising one or more kinds of additives selected from the compound consisting of tin type, calcium-zinc type, and lead type thermal stabilizers; acrylic type, butadiene type and CPE type impact modifiers; and calcium carbonate and acrylic processing aids.

3. The polyvinyl chloride foams according to claim 1, wherein the specific gravity of said polyvinyl chloride foams is 0.3 to 1.5, or the cell density is 10⁸ to 10¹² cells/cm³, or the average cell size is 1 to 100 μm.

4. The polyvinyl chloride foams according to claim 1 comprising 0.01 to 10 parts by weight of said layered silicate and 0.01 to 10 parts by weight of said foaming agent based on 100 parts by weight of said vinyl chloride resin.

5. The polyvinyl chloride foams according to claim 1, wherein said layered silicate is a smectite-group mineral selected from the group consisting of montmorillonite, bentonite, hectorite, fluorohectorite, saponite, beidelite, nontronite, stevensite, vermiculite, volkonskoite, sauconite, magadite, kenyalite, and their derivatives.

6. The polyvinyl chloride foams according to claim 1, wherein said foaming agents are one or more kinds of foaming agents selected from the group consisting of chemical foaming agents, physical foaming agents, and the mixture of chemical foaming agents and physical foaming agents.

7. The polyvinyl chloride foams according to claim 6, wherein said chemical foaming agents are selected from the group consisting of azodicarbonamide, azodiisobutyro-nitrile, benzenesulfonhydrizide, 4,4-oxybenzene sulfonyl-semicarbazide, p-toluene sulfonyl semi-carbazide, barium azodicarboxylate, N,N′-dimethyl-N,N′-dinitrosoterephthalamide, and trihydrazino triazine.

8. The polyvinyl chloride foams according to claim 6, wherein said physical foaming agents are inorganic foaming agents selected from the group consisting of carbon dioxide, nitrogen, argon, water, air, and helium; or organic foaming agents selected from the group consisting of aliphatic hydrocarbons containing 1 to 9 carbon atoms, aliphatic alcohols containing 1 to 3 carbon atoms, and halogenated aliphatic hydrocarbons containing 1 to 4 carbon atoms.
